(19) United States
(12) Patent Application Publication
(10) Pub. No.: US 2026/0362281 A1
(43) Pub. Date: Nov. 12, 2026

(54) Communication Method and Communication Device for Handling User Equipment Route Selection Policy

(71) Applicant: MEDIATEK INC., Hsin-Chu (TW)

(72) Inventor: Yuan-Chieh Lin, Hsinchu City (TW)

(73) Assignee: MEDIATEK INC., Hsin-Chu (TW)

(21) Appl. No.: 19/475,049

(22) PCT Filed: Sep. 12, 2024
(86) PCT No.: PCT/CN2024/118396

§ 371 Date: Oct. 13, 2025

Related U.S. Application Data
(60) Provisional application No. 63/588,305, filed on Oct. 6, 2023.
(60) Provisional application No. 63/589,348, filed on Oct. 11, 2023.

(51) Int. Cl. H04W 40/02; H04W 60/00; H04W 84/04

(52) U.S. Cl. CPC H04W 40/02; H04W 60/005; H04W 84/042

(57) ABSTRACT

A method for a User Equipment (UE) to handle UE route selection policy (URSP) is provided, wherein the UE has registered to a first public land mobile network (PLMN) and a second PLMN, and has a plurality of URSPs. The method includes receiving a request for information of a Protocol Data Unit (PDU) session via which to send a PDU of an application or a Personal IoT Network (PIN) from upper layers; and in response to the request, evaluating URSP rules in a first order of the plurality of URSPs when the first PLMN and the second PLMN are visited PLMNs or in a second order of the plurality of URSPs when one of the first PLMN and the second PLMN is a home PLMN, until a matching URSP rule is found.

### CROSS REFERENCE TO RELATED APPLICATION

This application claims the benefit of U.S. Provisional Application No. 63/588,305, filed on Oct. 6, 2023. Further, this application claims the benefit of U.S. Provisional Application No. 63/589,348, filed on Oct. 11, 2023. The contents of these applications are incorporated herein by reference.

### BACKGROUND OF THE INVENTION

### 1. Field of the Invention

The present invention relates to a communication method and a communication device used in a wireless communication system, and more particularly, to a communication method and a communication device for handling insufficient network supportability.

### 2. Description of the Prior Art

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless networks, such as GSM, CDMA, and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3rd generation partner project (3GPP) network normally includes a hybrid of 2G/3G/4G systems. The Next Generation Mobile Network (NGMN) board has decided to focus the future NGMN activities on defining the end-to-end requirements for 5G new radio (NR) systems (5GS).

The UE policies for 5GS include UE route selection policy (URSP) and access network discovery and selection policy (ANDSP). The UE policies can be delivered from a Policy Control Function (PCF) to UE. PCF takes care of network policies to manage network behavior. PCF gets the subscription information from Unified Data Management (UDM). PCF interfaces to both Access and Mobility Function (AMF) to manage the mobility context and Session Management Function (SMF) to manage the session contexts. PCF triggers the URSP which enables the UE to determine how a certain application should be handled.

More specifically, in 4G evolved packet system (EPS), a Packet Data Network (PDN) connectivity procedure is an important process when the communication system accesses to the packet data network. The purpose of PDN connectivity procedure is to set up a default EPS bearer between a UE and the packet data network. In 5G, a Protocol Data Unit (PDU) session establishment is a parallel procedure of the PDN connectivity procedure in 4G. A PDU session defines the association between the UE and the data network that provides a PDU connectivity service. When an application is executed, the upper layer of the UE sends the application information to the URSP entity for matching a URSP rule (i.e., by evaluating the traffic descriptor), and use the corresponding RSD (Route Selection Descriptor) of the selected URSP rule to associate with an existing PDU session or to establish a new PDU session.

There are several different types of URSP, ex: (1) PLMN generic (PG) URSP: URSP rules applicable in any PLMN; and (2) VPLMN specific (VPS) URSP: URSP rules applicable when the RPLMN or an equivalent PLMN is a VPLMN.

### SUMMARY OF THE INVENTION

In 5GS, UEs may simultaneously register to multiple public land mobile networks (PLMN“s”). However, the prior art does not consider the URSP rule evaluation when the UE registers to multiple public land mobile networks (PLMN“s”). A solution is sought.

Therefore, the present invention is to provide a communication method and a communication device to improve the drawbacks of the prior art.

An embodiment of the present invention discloses a method for a User Equipment (UE) to handle UE route selection policy (URSP), wherein the UE has registered to a first public land mobile network (PLMN) and a second PLMN, and has a plurality of URSPs. The method comprises receiving a request for information of a Protocol Data Unit (PDU) session via which to send a PDU of an application or a Personal IoT Network (PIN) from upper layers; and in response to the request, evaluating URSP rules in a first order of the plurality of URSPs when the first PLMN and the second PLMN are visited PLMNs or in a second order of the plurality of URSPs when one of the first PLMN and the second PLMN is a home PLMN, until a matching URSP rule is found.

Another embodiment of the present invention discloses a User Equipment (UE), which comprises a registering circuit that registers to a first public land mobile network (PLMN) and a second PLMN; an upper layer handling circuit that receives a request for information of a Protocol Data Unit (PDU) session via which to send a PDU of an application or a Personal IoT Network (PIN) from upper layers; and a control circuit that evaluates UE route selection policy (URSP) rules in a first order of the plurality of URSPs when the first PLMN and the second PLMN are visited PLMNs or in a second order of the plurality of URSPs when one of the first PLMN and the second PLMN is a home PLMN, until a matching URSP rule is found, in response to the request.

Another embodiment of the present invention discloses a method for a User Equipment (UE) to handle UE route selection policy (URSP), wherein the UE has registered to both a first public land mobile network (PLMN) and a visited PLMN. The method comprises receiving a request for applying URSP from upper layers; and in response to the request, considering as a visited PLMN specified (VPS) URSP all UE policy parts with URSP contents currently stored at the UE, only when the first PLMN is visited PLMN.

Another embodiment of the present invention discloses a non-transitory computer-readable medium storing instructions that, when executed by a processor of a User Equipment (UE), cause the UE to perform operations comprising registering to a first public land mobile network (PLMN) and a second PLMN; receiving a request for information of a Protocol Data Unit (PDU) session via which to send a PDU of an application or a Personal IoT Network (PIN) from upper layers; and evaluating UE route selection policy (URSP) rules in a first order of the plurality of URSPs when the first PLMN and the second PLMN are visited PLMNs or in a second order of the plurality of URSPs when one of the first PLMN and the second PLMN is a home PLMN, until a matching URSP rule is found, in response to the request.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system.

FIG. 2 is a schematic diagram of a communication device according to an example of the present invention.

FIG. 3 is a flowchart of a process according to an example of the present invention.

FIG. 4 is a flowchart of a process according to another example of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. “Approximately” means that within the acceptable error range, a person with ordinary knowledge in the field can solve the technical problem within a certain error range and basically achieve the technical effect. Also, the term “couple” is intended to mean either an indirect or direct, wired or wireless electrical connection.

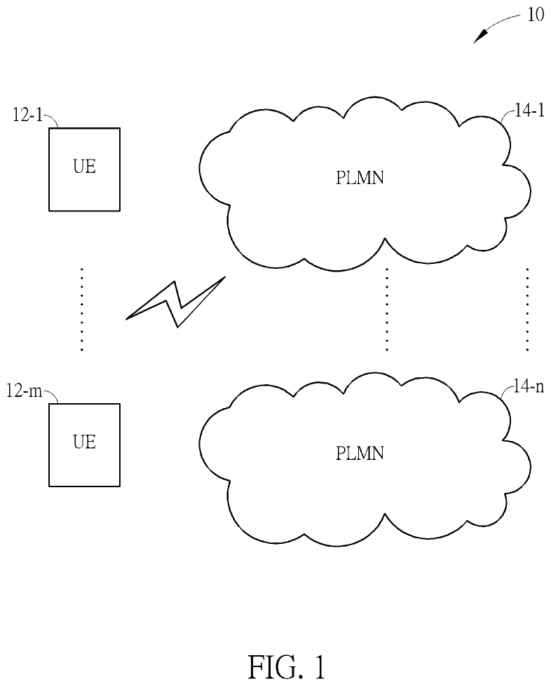

Please refer to FIG. 1. FIG. 1 is a schematic diagram of a wireless communication system 10. The wireless communication system 10 is briefly composed of a plurality of user equipments (UEs) 12_1 to 12_m and a plurality of public land mobile networks (PLMNs) 14_1 to 14_n. Each of the UEs 12_1 to 12_m may be a low cost device (e.g., machine type communication (MTC) device), a device-to-device (D2D) communication device, a narrow-band internet of things (IoT) (NB-IoT), a mobile phone, a laptop, a tablet computer, an electronic book, a portable computer system, or combination thereof. Each of the PLMNs 14_1 to 14_n represents a network that provides various wireless communication services within a specific country, operated by a particular Mobile Network Operator (MNO). A PLMN may support one or multiple cellular technologies such as UMTS/3G, LTE/4G, and NR/5G. For each of the UEs 12_1 to 12_m, the PLMNs 14_1 to 14_n may be classified into different types. For example, Registered PLMN (RPLMN) represents a PLMN registered by the UE after the last power-on or before network disconnection, Equivalent PLMN (EPLMN) represents a PLMN with the same status and priority as the PLMN currently selected by the UE, Home PLMN (HPLMN) represents a PLMN corresponding to IMSI of the UE, and Visited PLMN (VPLMN) represents a PLMN visited by the UE.

As well known in the art, the architecture of the 5G system is divided into two main components: the Radio Access Network (RAN) and the Core Network (CN). The RAN consists of the base stations and antennas that connect mobile devices to the core network, while the CN is the backbone that manages all the data and internet connections.

Within the 5G Core Network (5GCN), several key functions are critical for the operation and management of the 5G system. The Access and Mobility Management Function (AMF) manages the connection and mobility aspects of UE and handles tasks such as authentication, authorization, and ensuring seamless handovers as devices move across different network cells. The AMF is a successor to the 4G Mobility Management Entity (MME) and is designed to support both 3GPP and non-3GPP access networks. The Session Management Function (SMF) manages the data sessions that allow user plane data to be sent or received, and is in charge of establishing, modifying, and terminating these sessions and selecting and controlling the User Plane Function (UPF), which handles the actual data transfer. The Policy Control Function (PCF) is responsible for implementing end-to-end policy management, defining policies for different network slices, and enabling service exposure to external applications. The policy management includes UE route selection policy (URSP), which is a pivotal concept in the architecture of 5G networks, focusing on the optimal routing of user data. URSP may select the best data path based on various factors such as network conditions, traffic load, and Quality of Service (QOS) requirements, so as to ensure that data traffic between UE and external Data Networks (DN) is managed efficiently through the 5GCN. This selection is governed by predefined policies set by network operators, which take into account parameters like latency, bandwidth, and cost.

The prior art has disclosed to use “PLMN generic (PG) URSP” if the UE registers to the HPLMN, and to use “VPLMN specific (VPS) URSP” if the UE register to “a” VPLMN. However, if the UE registers to two or more different PLMNs, how to apply the URSP is not defined in the prior art.

Specifically, the UE and the 5GCN may configure URSP via a UE policy management process. In the UE policy management process, the UE sends a Registration Request message including a Payload Container Information Element (IE) with a Payload Container type set as UE policy container to the AMF to trigger a UE STATE INDICATION process. Accordingly, the AMF initiates a user policy association request to the PCF, and the PCF determines whether to install a new user policy or whether an existing user policy should be updated. Then, the PCF sends a MANAGE UE POLICY COMMAND message to the UE (via the AMF), to request the UE to manage UE policy sections. The MANAGE UE POLICY COMMAND message includes a VPS URSP configuration IE, which is used to transfer the VPS URSP configuration from the PCF to the UE. The VPS URSP configuration contains zero or more tuples. Each tuple contains the tuple ID identifying the tuple, the network descriptor identifying one or more VPLMNs, and zero or more UE Policy Section Codes (UPSCs) of HPLMN's UE policy sections which contain solely one or more UE policy parts with the UE policy part type set to “URSP”, such that the URSP rules in those one or more UE policy parts are applicable to the VPLMN and its equivalent PLMN. Thus, the UE may apply a VPS URSP rule when the RPLMN of the UE is a VPLMN listed in the VPS URSP configuration.

As to the association of the VPS URSP rules in the UE, the current 3GPP technical specifications have disclosed:

“For a UE not operating in Stand-alone Non-Public Network (SNPN) access operation mode, if the UE supports VPS URSP and has signalled URSP, when the upper layers request information of the PDU session via which to send a PDU of an application or a Personal IoT Network (PIN), the UE shall evaluate URSP rules in accordance with the following order until a matching URSP rule is found:
1) if “the” RPLMN is “a” VPLMN, non-default URSP rules in the VPS URSP of the RPLMN;
2) if “the” RPLMN is “a” VPLMN, non-default URSP rules in the VPS URSP of the equivalent PLMN of the RPLMN;
3) non-default URSP rules in the PG URSP;
4 ) UE local configuration for the application or the Personal IoT Network (PIN);
5) if “the” RPLMN is “a” VPLMN, default URSP rule in the VPS URSP of the RPLMN;
6) if “the” RPLMN is “a” VPLMN, default URSP rules in the VPS URSP of the equivalent PLMN of the RPLMN; and
7) default URSP rule in the PG URSP.″

However, the criteria of the current 3GPP technical specifications do not consider that the UE may register to two different PLMNs, i.e., two RPLMNs. For example, a UE may register to RPLMN 1 via 3GPP access and register to RPLMN 2 via non-3GPP access, where the RPLMN 1 is HPLMN and the RPLMN 2 is “a” VPLMN (i.e., one of “the RPLMN is a VPLMN”). In such a situation, applying the above bullets 1), 2), 5), and 6) is not feasible, because whenever the UE has registered to HPLMN, all the VPS URSP shall not be used (i.e., bullets 1), 2), 5), and 6) shall be skipped), and at HPLMN only “PG URSP (bullets 3) and 7)) and UE local configuration (bullet 4))” shall be used.

The same deficiency also occurs during UE policy re-assembly at the UE. For example, the current 3GPP technical specifications have disclosed:

“When the UE needs to apply URSP, the UE shall consider all UE policy parts with URSP contents currently stored at the UE.
a) If the UE Supports VPS URSP then:
   1) the UE shall consider as VPS URSP of the RPLMN all UE policy parts with URSP contents currently stored at the UE, which are a part of one or more UE policy sections identified by a UPSI:
      i) with the PLMN ID part indicating the HPLMN; and
      ii) with UPSC indicated in a tuple of the stored VPS URSP configuration, such that the tuple contains the network descriptor with a network descriptor entry containing:
         A) the network descriptor entry type field set to “one or more VPLMNs” and the network descriptor entry value field containing PLMN ID of the RPLMN, if “the” RPLMN is “a” VPLMN;
         B) the network descriptor entry type field set to “one or more MCCs” and the network descriptor entry value field containing MCC of the PLMN ID of the RPLMN, if “the” RPLMN is “a” VPLMN; or
         C) the network descriptor entry type field set to “any VPLMN”, if “the” RPLMN is “a” VPLMN;
   2) the UE shall consider as VPS URSP of the equivalent PLMN of the RPLMN all UE policy parts with URSP contents currently stored at the UE, which are a part of one or more UE policy sections identified by a UPSI:
      i) with the PLMN ID part indicating the HPLMN; and
      ii) with UPSC indicated in a tuple of the stored VPS URSP configuration, such that the tuple contains the network descriptor with a network descriptor entry containing:
         A) the network descriptor entry type field set to “one or more VPLMNs” and the network descriptor entry value field containing PLMN ID of an equivalent PLMN, if the equivalent PLMN is a VPLMN;
         B) the network descriptor entry type field set to “one or more MCCs” and the network descriptor entry value field containing MCC of the PLMN ID of an equivalent PLMN, if the equivalent PLMN is a VPLMN; or
         C) the network descriptor entry type field set to “any VPLMN”, if the equivalent PLMN is a VPLMN.″

As can be seen, the current 3GPP technical specifications do not consider that the UE may register to two RPLMNs. For example, a UE may register to RPLMN 1 via 3GPP access and register to RPLMN 2 via non-3GPP access, where the RPLMN 1 is HPLMN and the RPLMN 2 is a VPLMN (i.e., one of “the RPLMN is a VPLMN”). In such a situation, applying the above bullets a) 1) and a) 2) is not feasible, because whenever the UE has registered to HPLMN, all the VPS URSP shall not be considered because as long as at least one of the RPLMN is HPLMN, then only “PG URSP” shall be considered.

To cure the deficiency of the current 3GPP technical specifications, the present invention provides communication devices and methods to handle VPS URSP, especially for the UE registering to a plurality of VPLMNs.

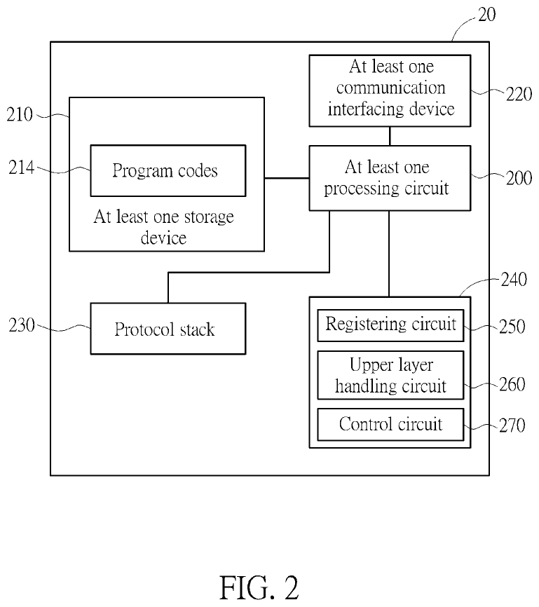

Please refer to FIG. 2, which is a schematic diagram of a communication device 20 according to an example of the present invention. The communication device 20 may be any of the UEs 12 1 to 12_m shown in FIG. 1, but is not limited herein. The communication device 20 may include at least one processing circuit 200 such as a microprocessor or Application Specific Integrated Circuit (ASIC), at least one storage device 210 and at least one communication interfacing device 220. The at least one storage device 210 may be any data storage device that may execute processes or store program codes 214, accessed and executed by the at least one processing circuit 200. Examples of the at least one storage device 210 include, but are not limited to, a subscriber identity module (SIM), read-only memory (ROM), flash memory, random-access memory (RAM), Compact Disc Read-Only Memory (CD-ROM), digital versatile disc-ROM (DVD-ROM), Blu-ray Disc-ROM (BD-ROM), hard disk, optical data storage device, non-volatile storage device, non-transitory computer-readable medium (e.g., tangible media), etc. The at least one communication interfacing device 220 is preferably at least one transceiver and is used to transmit and receive signals (e.g., data, messages and/or packets) according to processing results of the at least one processing circuit 200.

In the example of FIG. 2, the communication device 20 also includes a protocol stack 230 and a system module and circuit set 240. The protocol stack 260 comprises application layer and other upper layers to manage different applications, Non-Access-Stratum (NAS) layer to communicate with an AMF entity connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. The system module and circuit set 240 may be implemented and configured by software, firmware, hardware, and/or combination thereof. In one example, the system module and circuit set 240 includes a registering circuit 250, an upper layer handling circuit 260 and a control circuit 270. The registering circuit 250 handles a registration procedure, and may register to a first PLMN and a second PLMN. The upper layer handling circuit 260 receives requests or commands from the upper layers. The control circuit 270 handles configuration and control parameters in response to requests or commands received by the upper layer handling circuit 260.

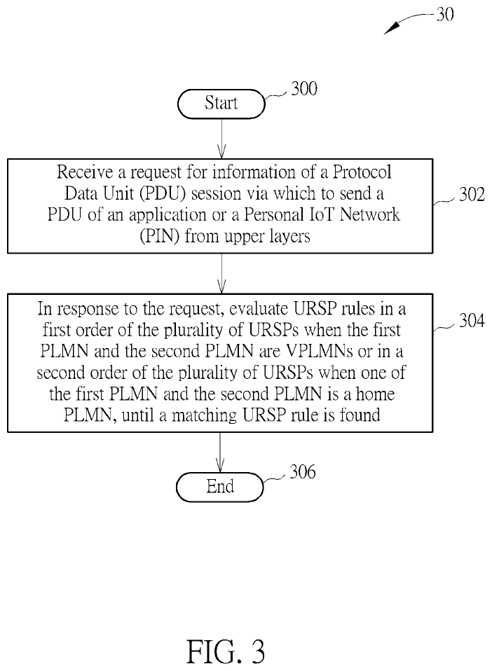

FIG. 3 is a flowchart of a process 30 according to an example of the present invention. The process 30 may be utilized in a UE (e.g., any of the UEs 12_1 to 12_m in FIG. 1, or the communication device 20 in FIG. 2), which does not operate in SNPN access operation mode, supports VPS URPS, and has a plurality of URSPs (e.g. stored in the at least one storage device 210). More importantly, the UE has registered to a first PLMN and a second PLMN (e.g. using the registering circuit 250). The process 30 may be executed by the system module and circuit set 240 shown in FIG. 2 and includes the following steps:
Step 300: Start.
Step 302: Receive a request for information of a Protocol Data Unit (PDU) session via which to send a PDU of an application or a Personal IoT Network (PIN) from upper layers.
Step 304: In response to the request, evaluate URSP rules in a first order of the plurality of URSPs when the first PLMN and the second PLMN are VPLMNs or in a second order of the plurality of URSPs when one of the first PLMN and the second PLMN is a home PLMN, until a matching URSP rule is found.

### Step 306: End.

According to the process 30, after the UE registers to the first PLMN and the second PLMN, the upper layers may send a request for information of a PDU session via which to send a PDU of an application or a PIN (Step 302). In response, the UE shall evaluate the URSP rules in different orders of the plurality of URSPs based on the types of the first PLMN and the second PLMN (Step 304). Specifically, when the first PLMN and the second PLMN are VPLMNs, the UE evaluates URSP rules in the first order, and when one of the first PLMN and the second PLMN is a HPLMN, the UE evaluates URSP rules in the second order.

Specifically, the plurality of URSPs comprise two or more of:
a) non-default URSP rules in a VPS URSP of a RPLMN;
b) non-default URSP rules in the VPS URSP of an equivalent PLMN of the RPLMN;
c) non-default URSP rules in a PG URSP;
d) UE local configuration for the application or the PIN;
e) default URSP rule in the VPS URSP of the RPLMN;
f) default URSP rules in the VPS URSP of the equivalent PLMN of the RPLMN; and
g) default URSP rule in the PG URSP.

The first order is corresponding to at least a part of a sequence of a) (if available), b) (if available), c) (if available), d) (if available), e) (if available), f) (if available) and g) (if available), and the second order is corresponding to at least a part of a sequence of c) (if available), d) (if available) and g) (if available). That is, if the plurality of URSPs comprise a), b), c) and d) (i.e., only a), b), c) and d) are available), then the first order is a), b), c) and d), and the second order is c) and d). If the plurality of URSPs comprise a), c) and g) (i.e., only a), c), and g) are available), then the first order is a), c) and g), and the second order is c) and g).

With the criteria, when the UE has registered to two PLMNs, the UE may accurately determine association between an application or a PIN and a PDU session based on the types of the PLMNs, so as to evaluate the URSP rules, and apply the matched URSP rule.

Note that, the process 30 aims at the scenario that the UE has registered to the first PLMN and the second PLMN. The process 30 may be compiled into the technical specifications, which may be:

“For a UE not operating in SNPN access operation mode, if the UE supports VPS URSP and has signalled URSP, when the upper layers request information of the PDU session via which to send a PDU of an application or a PIN, the UE shall evaluate URSP rules in accordance with the following order until a matching URSP rule is found:
1′) if the UE is registered via one or both accesses and the RPLMN of each access is a VPLMN, non-default URSP rules in the VPS URSP of the RPLMN;
2′) if the UE is registered via one or both accesses and the RPLMN of each access is a VPLMN, non-default URSP rules in the VPS URSP of the equivalent PLMN of the RPLMN;
3′) non-default URSP rules in the PG URSP;
4′) UE local configuration for the application or the Personal IoT Network (PIN);
5′) if the UE is registered via one or both accesses and the RPLMN of each access is a VPLMN, default URSP rule in the VPS URSP of the RPLMN;
6′) if the UE is registered via one or both accesses and the RPLMN of each access is a VPLMN, default URSP rules in the VPS URSP of the equivalent PLMN of the RPLMN; and
7′) default URSP rule in the PG URSP.″

The above bullets 3′), 4′), 7′) are succeeded from the current 3GPP technical specifications. However, the bullets 1′), 2′), 5′) and 6′) further consider whether the UE is registered via one or both accesses and the RPLMN of each access is a VPLMN. Therefore, if the UE has registered to two PLMNs, the bullets from 1′) to 7′) are one-by-one evaluated (until one of the bullets is matched) only when both the two PLMNs are VPLMN; otherwise, i.e., one of the two PLMNs is HPLMN, only the bullets 3′), 4′) and 7′) are evaluated (until one of the bullets is matched).

As can be seen, even if the UE registers to a plurality of VPLMNs, the UE may accurately determine association between an application or a PIN and a PDU session based on the types of the PLMNs according to the process 30 of the present invention.

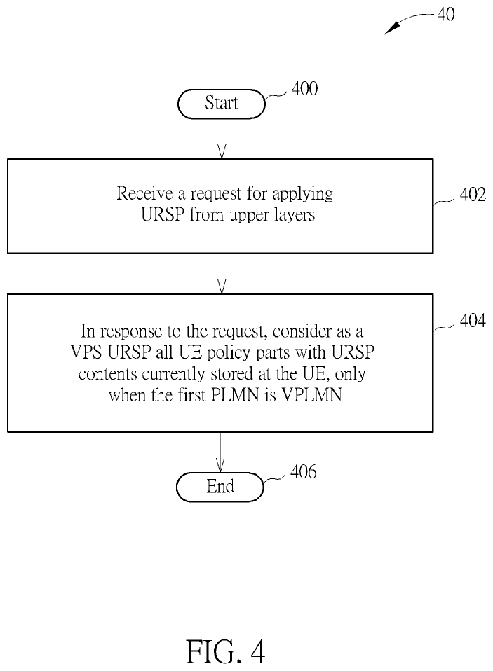

FIG. 4 is a flowchart of a process 40 according to an example of the present invention. The process 40 may be utilized in a UE (e.g., any of the UEs 12_1 to 12_m in FIG. 1, or the communication device 20 in FIG. 2), which supports VPS URPS, and has stored a VPS URSP configuration (e.g. in the at least one storage device 210). More importantly, the UE has registered to both a first PLMN and a visited PLMN (e.g. using the registering circuit 250). The process 40 may be executed by the system module and circuit set 240 shown in FIG. 2 and includes the following steps:
Step 400: Start.
Step 402: Receive a request for applying URSP from upper layers.
Step 404: In response to the request, consider as a VPS URSP all UE policy parts with URSP contents currently stored at the UE, only when the first PLMN is VPLMN.
Step 406: End.

According to the process 40, after the UE registers to the first PLMN and the visited PLMN, the upper layers may send a request for applying URSP (Step 402). In response, the UE shall consider as a VPS URSP all UE policy parts with URSP contents currently stored at the UE, only when the first PLMN is VPLMN (Step 404). In other words, only if the first PLMN is also VPLMN can the UE consider as a VPS URSP all UE policy parts with URSP contents currently stored at the UE; otherwise, i.e., the first PLMN is HPLMN, the UE would skip executing the Step 404.

Note that, the UE policy parts are a part of one or more UE policy sections identified by a UE Policy Section Identifier (UPSI) with a UE Policy Section Code (UPSC) indicated in a tuple of the VPS URSP configuration. Thus, when the VPS URSP is of the RPLMN, the tuple may contain a network descriptor with a network descriptor entry containing a network descriptor entry type field set to “one or more VPLMNs” and a network descriptor entry value field containing PLMN ID of the RPLMN of an access; the network descriptor entry type field set to “one or more MCCs” and the network descriptor entry value field containing MCC of the PLMN ID of the RPLMN of an access; or the network descriptor entry type field set to “any VPLMN”. Or, when the VPS URSP is of an equivalent PLMN of the RPLMN, the tuple may contain a network descriptor with a network descriptor entry containing a network descriptor entry type field set to “one or more VPLMNs” and a network descriptor entry value field containing PLMN ID of the equivalent PLMN, if the equivalent PLMN is a VPLMN; the network descriptor entry type field set to “one or more MCCs” and the network descriptor entry value field containing MCC of the PLMN ID of the equivalent PLMN, if the equivalent PLMN is a VPLMN; or the network descriptor entry type field set to “any VPLMN”, if the equivalent PLMN is a VPLMN.

With the criteria, when the UE has registered to two PLMNs, the UE may accurately determine UE policy re-assembly.

Note that, the process 40 aims at the scenario that the UE has registered to the first PLMN and the visited PLMN. The process 40 may be compiled into the technical specifications, which may be:

“When the UE needs to apply URSP, the UE shall consider all UE policy parts with URSP contents currently stored at the UE.
a) if the UE supports VPS URSP then:
   1) the UE shall consider as VPS URSP of the RPLMN all UE policy parts with URSP contents currently stored at the UE, which are a part of one or more UE policy sections identified by a UPSI:
      i) with the PLMN ID part indicating the HPLMN; and
      ii) with UPSC indicated in a tuple of the stored VPS URSP configuration, such that the tuple contains the network descriptor with a network descriptor entry containing:
         A′) the network descriptor entry type field set to “one or more VPLMNs” and the network descriptor entry value field containing PLMN ID of the RPLMN of an access, if the UE is registered via one or both accesses and the RPLMN of each access is a VPLMN;
         B′) the network descriptor entry type field set to “one or more MCCs” and the network descriptor entry value field containing MCC of the PLMN ID of the RPLMN of an access, if the UE is registered via one or both accesses and the RPLMN of each access is a VPLMN; or
         C′) the network descriptor entry type field set to “any VPLMN”, if the UE is registered via one or both accesses and the RPLMN of each access is a VPLMN;
   2) the UE shall consider as VPS URSP of the equivalent PLMN of the RPLMN all UE policy parts with URSP contents currently stored at the UE, which are a part of one or more UE policy sections identified by a UPSI:
      i) With the PLMN ID part indicating the HPLMN; and
      ii) with UPSC indicated in a tuple of the stored VPS URSP configuration, such that the tuple contains the network descriptor with a network descriptor entry containing:
         A″) the network descriptor entry type field set to “one or more VPLMNs” and the network descriptor entry value field containing PLMN ID of an equivalent PLMN, if the UE is registered via one or both accesses, the RPLMN of each access is a VPLMN and the equivalent PLMN is a VPLMN;
         B″) the network descriptor entry type field set to “one or more MCCs” and the network descriptor entry value field containing MCC of the PLMN ID of an equivalent PLMN, if the UE is registered via one or both accesses, the RPLMN of each access is a VPLMN and the equivalent PLMN is a VPLMN; or
         C″) the network descriptor entry type field set to “any VPLMN”, if the UE is registered via one or both accesses, the RPLMN of each access is a VPLMN and an equivalent PLMN is a VPLMN.″

As can be seen, the bullets A′) to C′) and A″) to C″) further consider whether the UE is registered via one or both accesses and the RPLMN of each access is a VPLMN, or an equivalent PLMN is a VPLMN. Therefore, if the UE has registered to two PLMNs, the bullets A′) to C′) and A″) to C″) are considered only if both the two PLMNs are VPLMN; otherwise, i.e., one of the two PLMNs is HPLMN, the bullets A′) to C′) and A″) to C″) are skipped.

As can be seen, even if the UE registers to a plurality of VPLMNs, the UE may accurately determine UE policy re-assembly.

In accordance with the processes 30 and 40, the UE having registering to two PLMNs may accurately determine association between an application or a PIN and a PDU session based on the types of the PLMNs, and determine UE policy re-assembly.

Note that, the processes 30 and 40 take two PLMNs as examples, and those skilled in the art may derive more than two PLMNs, which is within the scope of the present invention.

In an example, the UE may register to a plurality of PLMNs, and the UE is allowed to apply VPS URSP only when all the PLMNs are VPLMNs. In other words, if one of the PLMNs is HPLMN, the UE shall apply PG URSP.

The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20.

Examples of the hardware may include analog circuit(s), digital circuit(s) and/or mixed circuit(s). For example, the hardware may include ASIC(s), field programmable gate array(s) (FPGA(s)), programmable logic device(s), coupled hardware components or combination thereof. In another example, the hardware may include general-purpose processor(s), microprocessor(s), controller(s), digital signal processor(s) (DSP(s)) or combination thereof.

Examples of the software may include set(s) of codes, set(s) of instructions and/or set(s) of functions retained (e.g., stored) in a storage unit, e.g., a computer-readable medium. The computer-readable medium may include SIM, ROM, flash memory, RAM, CD-ROM/DVD-ROM/BD-ROM, magnetic tape, hard disk, optical data storage device, non-volatile storage unit, or combination thereof. The computer-readable medium (e.g., storage unit) may be coupled to at least one processor internally (e.g., integrated) or externally (e.g., separated). The at least one processor which may include one or more modules may (e.g., be configured to) execute the software in the computer-readable medium. The set(s) of codes, the set(s) of instructions and/or the set(s) of functions may cause the at least one processor, the module(s), the hardware and/or the electronic system to perform the related steps.

Examples of the electronic system may include a system on chip (SoC), system in package (SiP), a computer on module (COM), a computer program product, an apparatus, a mobile phone, a laptop, a tablet computer, an electronic book or a portable computer system, and the communication device 20.

To sum up, the present invention provides a communication device and method for handling URSP. When the UE has registered to a plurality of PLMNs, the VPS URSP may be applied only when all the PLMNs are VPLMNs. Thus, the communication device may accurately determine association between an application or a PIN and a PDU session and accurately determine UE policy re-assembly. The issue of insufficient network supportability is, therefore, overcome.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a User Equipment (UE) to handle UE route selection policy (URSP), wherein the UE has registered to a first public land mobile network (PLMN) and a second PLMN, and has a plurality of URSPs, the method comprising:
receiving a request for information of a Protocol Data Unit (PDU) session via which to send a PDU of an application or a Personal IoT Network (PIN) from upper layers; and
in response to the request, evaluating URSP rules in a first order of the plurality of URSPs when the first PLMN and the second PLMN are visited PLMNs or in a second order of the plurality of URSPs when one of the first PLMN and the second PLMN is a home PLMN, until a matching URSP rule is found.

2. The method of claim 1, wherein the plurality of URSPs comprise two or more of:
a) non-default URSP rules in a visited PLMN specified (VPS) URSP of a registered PLMN (RPLMN);
b) non-default URSP rules in the VPS URSP of an equivalent PLMN of a RPLMN;
c) non-default URSP rules in a PLMN generic (PG) URSP;
d) UE local configuration for the application or the PIN;
e) default URSP rule in the VPS URSP of a RPLMN;
f) default URSP rules in the VPS URSP of an equivalent PLMN of a RPLMN; and
g) default URSP rule in the PG URSP.

3. The method of claim 2, wherein the first order is corresponding to at least a part of a sequence of a), b), c), d), e), f) and g), and the second order is corresponding to at least a part of a sequence of c), d) and g).

4. The method of claim 1, wherein the UE does not operate in a Stand-alone Non-Public Network (SNPN) access operation mode.

5. A User Equipment (UE), comprising:
a registering circuit that registers to a first public land mobile network (PLMN) and a second PLMN;
an upper layer handling circuit that receives a request for information of a Protocol Data Unit (PDU) session via which to send a PDU of an application or a Personal IoT Network (PIN) from upper layers; and
a control circuit that evaluates UE route selection policy (URSP) rules in a first order of the plurality of URSPs when the first PLMN and the second PLMN are visited PLMNs or in a second order of the plurality of URSPs when one of the first PLMN and the second PLMN is a home PLMN, until a matching URSP rule is found, in response to the request.

6. The UE of claim 5, wherein the plurality of URSPs comprise two or more of:
a) non-default URSP rules in a visited PLMN specified (VPS) URSP of a registered PLMN (RPLMN);
b) non-default URSP rules in the VPS URSP of an equivalent PLMN of a RPLMN;
c) non-default URSP rules in a PLMN generic (PG) URSP;
d) UE local configuration for the application or the PIN;
e) default URSP rule in the VPS URSP of a RPLMN;
f) default URSP rules in the VPS URSP of an equivalent PLMN of a RPLMN; and
g) default URSP rule in the PG URSP.

7. The UE of claim 6, wherein the first order is corresponding to at least a part of a sequence of a), b), c), d), e), f) and g), and the second order is corresponding to at least a part of a sequence of c), d) and g).

8. The UE of claim 5, wherein the UE does not operate in a Stand-alone Non-Public Network (SNPN) access operation mode.

9. A method for a User Equipment (UE) to handle UE route selection policy (URSP), wherein the UE has registered to both a first public land mobile network (PLMN) and a visited PLMN, the method comprising:
receiving a request for applying URSP from upper layers; and
in response to the request, considering as a visited PLMN specified (VPS) URSP all UE policy parts with URSP contents currently stored at the UE, only when the first PLMN is visited PLMN.

10. The method of claim 9, wherein the VPS URSP is of a registered PLMN (RPLMN).

11. The method of claim 10, wherein the UE has stored a VPS URSP configuration, and the UE policy parts are a part of one or more UE policy sections identified by a UE Policy Section Identifier (UPSI) with a UE Policy Section Code indicated in a tuple of the VPS URSP configuration, such that the tuple contains a network descriptor with a network descriptor entry containing:
a network descriptor entry type field set to “one or more VPLMNs” and a network descriptor entry value field containing PLMN ID of the RPLMN of an access;
the network descriptor entry type field set to “one or more MCCs” and the network descriptor entry value field containing MCC of the PLMN ID of the RPLMN of an access; or
the network descriptor entry type field set to “any VPLMN”.

12. The method of claim 9, wherein the VPS URSP is of an equivalent PLMN of a registered PLMN.

13. The method of claim 12, wherein the UE has stored a VPS URSP configuration, and the UE policy parts are a part of one or more UE policy sections identified by a UE Policy Section Identifier (UPSI) with a UE Policy Section Code indicated in a tuple of the VPS URSP configuration, such that the tuple contains a network descriptor with a network descriptor entry containing:
a network descriptor entry type field set to “one or more VPLMNs” and a network descriptor entry value field containing PLMN ID of the equivalent PLMN, if the equivalent PLMN is a VPLMN;
the network descriptor entry type field set to “one or more MCCs” and the network descriptor entry value field containing MCC of the PLMN ID of the equivalent PLMN, if the equivalent PLMN is a VPLMN; or
the network descriptor entry type field set to “any VPLMN”, if the equivalent PLMN is a VPLMN.

14. A non-transitory computer-readable medium storing instructions that, when executed by a processor of a User Equipment (UE), cause the UE to perform operations comprising:
registering to a first public land mobile network (PLMN) and a second PLMN;
receiving a request for information of a Protocol Data Unit (PDU) session via which to send a PDU of an application or a Personal IoT Network (PIN) from upper layers; and
evaluating UE route selection policy (URSP) rules in a first order of the plurality of URSPs when the first PLMN and the second PLMN are visited PLMNs or in a second order of the plurality of URSPs when one of the first PLMN and the second PLMN is a home PLMN, until a matching URSP rule is found, in response to the request.

15. The non-transitory computer-readable medium of claim 14, wherein the plurality of URSPs comprise two or more of:
a) non-default URSP rules in a visited PLMN specified (VPS) URSP of a registered PLMN (RPLMN);
b) non-default URSP rules in the VPS URSP of an equivalent PLMN of a RPLMN;
c) non-default URSP rules in a PLMN generic (PG) URSP;
d) UE local configuration for the application or the PIN;
e) default URSP rule in the VPS URSP of a RPLMN;
f) default URSP rules in the VPS URSP of an equivalent PLMN of a RPLMN; and
g) default URSP rule in the PG URSP.

16. The non-transitory computer-readable medium of claim 15, wherein the first order is corresponding to at least a part of a sequence of a), b), c), d), e), f) and g), and the second order is corresponding to at least a part of a sequence of c), d) and g).

17. The non-transitory computer-readable medium of claim 14, wherein the UE does not operate in a Stand-alone Non-Public Network (SNPN) access operation mode.
